(19) United States
(12) Patent Application Publication
(10) Pub. No.: US 2007/0022994 A1
(43) Pub. Date: Feb. 1, 2007

(54) Remote starter for a pump

(75) Inventor: Peter Moskun, Quebec (CA)

Correspondence Address: Dean D. Small;THE SMALL PATENT LAW GROUP LLP, SUITE 1611, 611 OLIVE STREET, SAINT LOUIS, MO, 63101, US

(73) Assignee: ANSUL CANADA LIMITED

(21) Appl. No.: 11/434,429

(22) Filed: May 15, 2006

Related U.S. Application Data
(60) Provisional application No. 60/703,740, filed on Jul. 29, 2005.

(51) Int. Cl. F02N 17/00

(52) U.S. Cl. 123/179.2

(57) ABSTRACT

Methods and apparatus for a remote starting system for an engine-driven pump are provided. The system includes a remote starter controller communicatively coupled to the engine-driven pump, and configured to transmit an engine start signal to the engine wherein the remote starter controller is positioned remotely from the engine-driven pump. The system includes an engine start sensor communicatively coupled to the engine and configured to determine whether the engine started in response to the engine start signal, and an engine start indicator configured to indicate to a user that the engine has started in response to the engine start signal.

### CROSS REFERENCE TO RELATED APPLICATIONS

This application is entitled to the benefit of, and claims priority to, provisional U.S. Patent Application Ser. No. 60/703,740, filed Jul. 29, 2005 and entitled “Remote Starter for a Pump”, which is hereby incorporated by reference in its entirety.

### BACKGROUND OF THE INVENTION

This invention generally relates to operating engine-driven machinery and more particularly, to methods and apparatus for remote starting of engine-driven machinery over great distances.

At least some known fluid pumps for use in for example, fighting fires, include an engine that drives one or more pump ends. Typically, before starting the pump, it must be primed; that is, fluid must be pumped into it manually so that it is filled with fluid. Then, after priming, a user manually starts the pump. Both operations, priming and starting, require the presence of the operator at the pump, possibly under extremely dangerous conditions.

However a user that is required to man a fire pump is often not available to fight the fire. In the case of some fires, the pump may be located a relatively large distance from the location where the fluid is being used such that the travel time to and from the pump location further increases the operator's time away from fire-fighting.

### BRIEF DESCRIPTION OF THE INVENTION

In one embodiment, a starting system for an engine-driven pump includes a starter controller communicatively coupled to the engine-driven pump, and configured to transmit an engine start signal to the engine wherein the starter controller is positioned remotely from the engine-driven pump. The system includes an engine start sensor communicatively coupled to the engine and configured to determine whether the engine started in response to the engine start signal, and an engine start indicator configured to indicate to a user that the engine has started in response to the engine start signal.

In another embodiment, a method for remotely starting a pump system is provided. The system includes an engine, a pump end driven by the engine, and a starter communicatively coupled to the engine. The method includes providing a start signal from the starter to the engine, starting the engine upon receipt of the start signal, detecting fluid pressure at the pump end, comparing the detected fluid pressure to a predetermined threshold, and transmitting a confirmation signal to the starter if the detected fluid pressure exceeds the predetermined threshold.

In yet another embodiment, an engine-driven pump assembly includes an engine including a starting system, a pump rotatably coupled to said engine, a starter controller communicatively coupled to the starting system, said controller configured to transmit an engine start signal to the starting system, said starter controller configured to determine whether the engine started in response to the engine start signal wherein the starter controller is remote from the engine-driven pump, and an engine start indicator configured to receive the engine start determination and to indicate to a user that the engine has started in response to the engine start signal.

### BRIEF DESCRIPTION OF THE DRAWINGS

FIG. 1 is a schematic diagram of an engine-driven pump in accordance with an exemplary embodiment of the present invention; and

FIG. 2 is a schematic illustration of exemplary embodiment of engine-driven pump shown in FIG. 1 with a priming system.

### DETAILED DESCRIPTION OF THE INVENTION

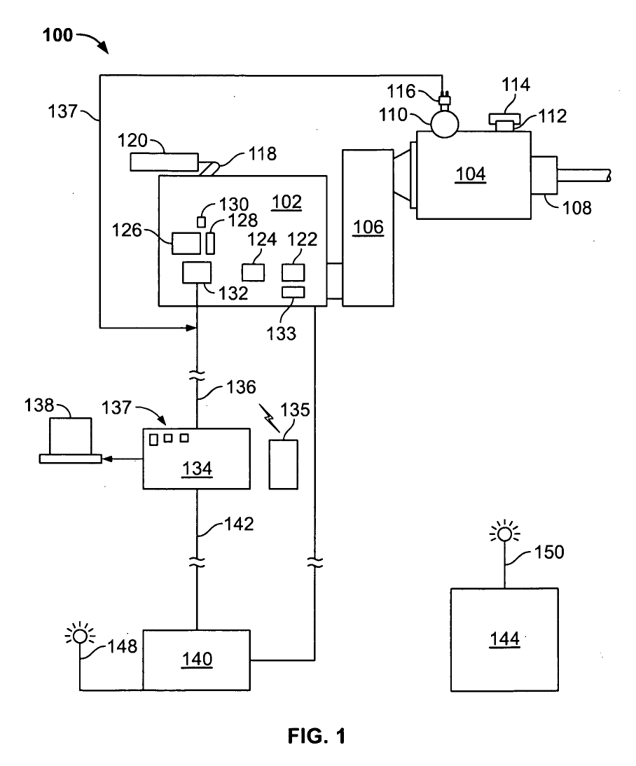

FIG. 1 is a schematic diagram of an engine-driven pump 100 in accordance with an exemplary embodiment of the present invention. Pump 100 includes an engine 102, for example, an internal combustion engine, and a pump end 104 drivingly coupled to engine 102. In the exemplary embodiment, pump end 104 and engine 102 are coupled through a speed changer 106, which is configured to transmit power from engine 102 to pump end 104 at a rotational speed directly proportional to a rotational speed of engine 102. In an alternative embodiment, speed changer 106 is configured to transmit power from engine 102 to pump end 104 at a rotational speed that is a function of a selectable engine operating parameter. In another alternative embodiment, engine 102 is directly coupled to pump end 104.

Pump end 104 includes a pump suction 108 configured to draw a fluid, such as, water and/or a fire-fighting media or other pumpable fluid, into pump end 104. Pump end 104 also includes a pump discharge 110 configured to direct an output of pump end 104 through a conduit (not shown), such as a hose, piping system, or combination thereof. A priming connection 112, which is generally covered by a priming cap 114, permits entry of fluid into a pumping cavity (not shown) in pump end 104 for priming pump end 104. Priming may be required if engine-driven pump 100 remains idle for a period of time, permitting fluid in the pumping cavity to leak out. Priming connection 112 permits adding fluid to the cavity manually or through a supply of fluid coupled to priming connection 112. Pump discharge 110 includes a pressure switch and/or flow switch 116 configured to sense a fluid pressure and/or flow in pump discharge 110 and to transmit a signal that is a function of the fluid pressure and/or flow in pump discharge 110.

Engine 102 includes a choke 118 and a choke actuator 120, generally used during starting when engine 102 is at a temperature that is less than normal operating temperature. An integral choke control engages choke 118 for start-up and disengages choke 118 once engine 102 is running. Choke 118 is configured to be operated manually and/or automatically. Engine 102 also includes a throttle 122 and a fuel injection system 124. Although a choke and a throttle are provided as examples, it would be understood by one skilled in the art that other additional components related to the operation of engine 102 could also be controlled and/or monitored.

Engine 102 also includes an engine starter 126 that is rotatably coupled to engine 102 through a gear 128 that is actuated by a solenoid 130 to engage a complementary gear (not shown) on engine 102. An engine control 132 receives inputs from various engine sensing components for parameters, such as, but not limited to RPM, fuel tank level, engine temperature, ambient temperature, pump discharge pressure, ambient pressure, engine oil temperature and pressure, and engine vibration, and generates control outputs to control engine 102 during operation. Each input is also used to generate alarm or warning signals if the measured input parameter is outside of predetermined operating limits. For example, an engine vibration input from an engine vibration sensor 133 is used to monitor engine operating performance. During startup of other transient operations, engine vibration may be higher than in a warm steady state operating condition. Engine control 132, sensing the operating condition of engine 102 modifies the engine vibration threshold limit to avoid an unnecessary alarm or engine shutdown during transient operation. Engine control 132 is also configured to transmit the engine sensing component outputs to other control devices for further processing.

A remote starter 134 is communicatively coupled to engine-driven pump 100 through a hard-wire connection such a wire or a fiber optic conduit, or a wireless connection 136. In the exemplary embodiment, remote starter 134 is mounted remotely from engine-driven pump 100 as a separate component, for example, as a retro-fit component. In this case “remotely” is defined as separate from engine-driven pump 100, but not necessarily at a great distance from engine-driven pump 100. In an alternative embodiment, remote starter 134 is incorporated into the control system of engine-driven pump 100. In various embodiments, remote starter 134 is programmed to perform several different tasks, for example, to start engine 102 at regular intervals, such as every two hours, start engine 102 and run for a designated or pre-designated interval, and then shut engine 102 down. Remote starter 134 is also programmed to attempt to start engine 102 up to a predetermined number of times (for example, three) upon failure of engine 102 to start upon command. As another example, remote starter 134 is programmed to start engine 102 at idle and uses throttle 122 to increase engine RPM to operating speed. Prior to shutting down, throttle 122 is used to lower engine RPM to idle before shutting engine 102 down. Such programming permits engine 102 to be remotely started, for example, every two hours to run sprinklers to soak down a house or area to efficiently use water. The programming may be coded to start engine 102 at a specific recurrent time or at a time relative to an event or a beginning time. A plurality of switches 137 includes an ‘on’ switch that permits the user to start the pump at remote starter 134, program switches that are used to program the unit to run for different periods of time, cycle the run times, program other handheld remotes. In the exemplary embodiment, a key interlocks with the ‘on’ switch to permit the user to start engine 102 at remote starter 134 and is also used during some programming functions, while at the same time limiting access to only authorized users.

Remote starter 134 is coupled to a strobe light 138 that permits a firefighter or pilot to determine a status of engine-driven pump 100 from across a wide area or from the air. Strobe light 138 is energized by remote starter 134 only if engine 102 is running and there is fluid pressure, i.e., fluid is available. In the exemplary embodiment, remote starter 134 receives signals relating to fluid pressure and flow available at pump discharge 110 and the vibration associated with engine 102. If the pressure, flow, and/or engine parameters are outside determined thresholds, remote starter 134 generates an alarm and or engine shutdown signal. In the exemplary embodiment, remote starter 134 is configured to communicate with a handheld remote control 135. For example, with remote starter 134 retrofitted to an existing pump (water, air, hydraulic, etc.) with pressure/flow switch 116 coupled to discharge 110, remote control 135 is capable of engine 102 remote starting from a range of approximately 3000 feet to approximately 6000 feet. The range of operation may be influenced by the terrain between handheld remote control 135 and remote starter 134. When pressure/flow switch 116 senses pressure and/or flow in discharge 110 and engine vibration is not excessive, pressure/flow switch 116 and vibration sensor 133 transmit an engine running signal to remote starter 134 through, for example, a wired connection 137 to indicate engine 102 is running. If pressure/flow switch 116 does not sense pressure and/or flow of predetermined quantities or vibration sensor 133 determines that engine vibration is excessive for the current operating conditions, remote starter 134 shuts down engine 102. Accordingly, if there is no fluid in the pump, i.e., the pump is running dry, remote starter 134 will secure engine 102 pump before damage to pump end 104 occurs. While engine 102 is running, if pump end 104 experiences a loss of prime, pressure/flow switch 116 will not sense pressure and/or flow and remote starter 134 will shutdown engine 102 before any damage to pump end 104 occurs.

In various alternative embodiments, remote starter 134 is coupled to a transmitter/receiver 140 communicatively coupled to remote starter 134 through a hard-wire or wireless connection 142. A transmitter/receiver 144 that is complementary to transmitter/receiver 140 is communicatively coupled to transmitter/receiver 140.

In one embodiment, transmitter/receiver 144 includes a home-base unit that communicates with transmitter/receiver 140 via long-range RF antennas 148 and 150 such that an operator at the home-base is able to start engine-driven pump 100. A start button (not shown) on the home-base unit allows the user to start engine-driven pump 100 and a confirmation light (not shown) on the home-base unit indicates when the pump is working/operating. Accordingly, in this embodiment, remote starter 134 is able to accept an add-on auxiliary RF transmitter/receiver, therefore increasing the range of remote starter 134. Additionally, transmitter/receiver 140 and transmitter/receiver 144 may be configured as a separate transmitter unit and receiver unit or may be configured as transceivers.

In another embodiment transmitter/receiver 140 and transmitter/receiver 144 communicate using satellite communications. A signal is sent to remote starter 134 via satellite. A user sends, for example, an email including commands for controlling remote starter 134. The commands are decoded at remote starter 134 or an intermediate point and a signal is transmitted to remote starter 134 initiating a start sequence for engine-driven pump 100. Upon successful startup of the pump, the user receives an email indicating that the pump is running. In an alternative embodiment, remote starter 134 includes a web interface configured to communicate to the Internet using, for example, a satellite communications connection. The web interface permits a remote user to access the functions of remote starter 134 to view the status on engine 102, operating parameters associated with engine 102, and to control engine 102 using the web interface.

In yet another embodiment a signal is transmitted to remote starter 134 via any type of telephone. A confirmation is transmitted to the user indicating whether engine-driven pump 100 is running.

In still yet another embodiment of the present invention a satellite modem is used to transmit information to the user regarding the performance of engine-driven pump 100 and ambient conditions. For example, with the addition of cameras into the pump, sensing footage can be sent back to the user. With such information, the use can control engine and pump end parameters based on a visual and/or video display.

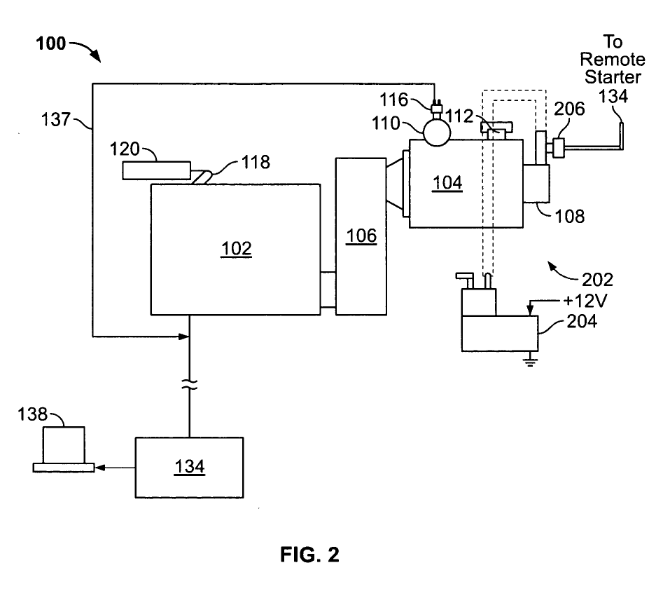

FIG. 2 is a schematic illustration of exemplary embodiment of engine-driven pump 100 (shown in FIG. 1) with a priming system 202 that includes a supply of priming fluid, such as a priming pump 204, a conduit between priming pump 204 and suction 108, and priming controls, such as an electric solenoid valve and check valve. If engine-driven pump 100 is not started for extended periods of time, a possibility that the pump may lose prime (no fluid in the pump end) exists. Therefore, in the exemplary embodiment, whenever the user remote starts engine-driven pump 100, remote starter 134 first primes pump end 104 using priming pump 204. Priming pump 204 stops automatically when fluid reaches a liquid/fluid monitor 206. Remote starter 134 is then enabled to start engine-driven pump 100.

The above-described remote starting system is a cost-effective and highly reliable system for facilitating operating equipment at relatively long range such that a user can operate the equipment rapidly and/or without endangering the user's health or life. Accordingly, the remote starting system facilitates operation of for example, fire-fighting or rescue equipment in a cost-effective and reliable manner.

While the invention has been described in terms of various specific embodiments, those skilled in the art will recognize that the invention can be practiced with modification within the spirit and scope of the claims.

What is claimed is:

1. A remote starting system for an engine-driven pump comprising:
a starter controller communicatively coupled to the engine-driven pump, and configured to transmit an engine start signal to the engine, wherein the starter controller is remote from the engine-driven pump;
an engine start sensor communicatively coupled to the engine and configured to determine whether the engine started in response to the engine start signal; and
an engine start indicator configured to indicate to a user that the engine has started in response to the engine start signal.

2. A remote starting system in accordance with claim 1 wherein the remote starter controller comprises a start switch that is configured to generate the start signal manually at the remote starter controller.

3. A remote starting system in accordance with claim 1 further comprising:
a first wireless transceiver communicatively coupled to the remote starter controller; and
a second wireless transceiver configured to communicatively couple to the first wireless transceiver, the second wireless transceiver configured to generate a remote engine start signal to be transmitted to said first wireless transceiver, the second wireless transceiver configured to receive a signal indicative of the engine start indicator.

4. A remote starting system in accordance with claim 1 wherein the engine-driven pump includes a pump priming connection and a fluid level sensor, the remote starter controller configured to prime the pump prior to transmitting the engine start signal.

5. A remote starting system in accordance with claim 1 wherein the remote starter controller is configured to receive signals that are a function of at least one of engine RPM, fuel tank level, engine temperature, ambient temperature, pump discharge pressure, ambient pressure, engine oil temperature, and engine oil pressure.

6. A remote starting system in accordance with claim 1 wherein the engine comprises a choke and a throttle, the remote starter controller is configured to engage the choke prior to transmitting the engine start signal and to control engine speed after the engine starts.

7. A method for remotely starting a pump system, the pump system comprising an engine, a pump end driven by the engine, and a remote starter communicatively coupled to the engine, the method comprising:
providing a start signal from the remote starter to the engine;
starting the engine upon receipt of the start signal;
detecting at least one of fluid pressure at the pump end, fluid flow from the pump end, and engine vibration;
comparing the at least one of fluid pressure at the pump end, fluid flow from the pump end, and engine vibration to a respective determined threshold; and
transmitting a confirmation signal from the remote starter if the at least one of fluid pressure at the pump end, fluid flow from the pump end, and engine vibration are within the predetermined threshold.

8. A method in accordance with claim 7 further comprising receiving, at the remote starter, a start signal from a handheld remote transmitter.

9. A method in accordance with claim 7 further comprising receiving, at the remote starter, a start signal from at least one of a radio frequency (RF) receiver, an RF transceiver, a satellite modem, a satellite phone, a wireless phone, and a landline phone.

10. A method in accordance with claim 7 wherein starting the engine upon receipt of the start signal comprises priming the pump end.

11. A method in accordance with claim 7 wherein starting the engine upon receipt of the start signal comprises engaging an engine choke.

12. A method in accordance with claim 7 wherein starting the engine upon receipt of the start signal comprises:
idling the engine at a predetermined idle speed; and
ramping the engine speed to a predetermined operating speed.

13. A method in accordance with claim 10 wherein priming the pump end detecting a level of fluid in the pump end.

14. A method in accordance with claim 7 wherein further comprises shutting down the engine when the detected fluid pressure is less than the predetermined threshold.

15. A method in accordance with claim 7 wherein comparing the detected fluid pressure to a predetermined threshold comprises comparing the detected fluid pressure to a predetermined threshold that is selectable based on a fluid volume demand.

16. An engine-driven pump assembly comprising:
an engine comprising a starting system;
a pump rotatably coupled to said engine;
a remote starter controller communicatively coupled to the starting system, said controller configured to transmit an engine start signal to the starting system, said remote starter controller configured to determine whether the engine started in response to the engine start signal wherein the remote starter controller is remote from the engine-driven pump; and
an engine start indicator configured to receive the engine start determination and to indicate to a user that the engine has started in response to the engine start signal.

17. An engine-driven pump assembly in accordance with claim 16 wherein the remote starter controller comprises a start switch that is configured to generate the start signal manually at the remote starter controller.

18. An engine-driven pump assembly in accordance with claim 16 further comprising:
a first wireless transceiver communicatively coupled to the remote starter controller; and
a second wireless transceiver configured to communicatively couple to the first wireless transceiver, the second wireless transceiver configured to generate a remote engine start signal to be transmitted to said first wireless transceiver, the second wireless transceiver configured to receive a signal indicative of the engine start indicator.

19. An engine-driven pump assembly in accordance with claim 16 wherein the engine-driven pump includes a pump priming connection and a fluid level sensor, the remote starter controller configured to prime the pump prior to transmitting the engine start signal.

20. An engine-driven pump assembly in accordance with claim 16 wherein the remote starter controller is configured to receive signals that are a function of at least one of engine RPM, engine vibration, fuel tank level, engine temperature, ambient temperature, pump discharge pressure, pump flow, am bient pressure, engine oil temperature, and engine oil pressure.
